(19) United States
(12) Patent Application Publication
(10) Pub. No.: US 2008/0205644 A1
(43) Pub. Date: Aug. 28, 2008

(54) Method for encrypting and decrypting an image frame

(75) Inventors: Hee-Jo Lee, Namyangju-city (KR); Eui-Jin Choo, Seoul (KR); Je-Hyun Lee, Seoul (KR); Gi-Won Nam, Gyeonggi-do (KR)

Correspondence Address: HARRITY SNYDER, LLP, 11350 Random Hills Road, SUITE 600, FAIRFAX, VA, 22030, US

(73) Assignee: KOREA UNIVERSITY INDUSTRY AND ACADEMY COLLABORATION FOUNDATION, Seoul (KR)

(21) Appl. No.: 11/905,240

(22) Filed: Sep. 28, 2007

(30) Foreign Application Priority Data
Feb. 22, 2007 (KR) 10-2007-0017966

(51) Int. Cl. H04N 7/167

(52) U.S. Cl. 380/210

(57) ABSTRACT

An apparatus for encrypting an image frame generates a key frame, performs XOR with the image frame and the key frame to generate a temporary image frame, and changes positions of blocks of the temporary image frame according to a first key to generate an encrypted image frame.

An apparatus for decrypting an image frame receives an encrypted image frame, generates a key frame, changes positions of blocks of the encrypted image frame according to a first key to generate a temporary image frame, and performs XOR with the temporary image frame and the key frame to generate the image frame.

### BACKGROUND OF THE INVENTION

1. Field of the Invention

The present invention relates to an image frame encryption method and an image frame decryption method. In particular, the present invention relates to an image frame encryption method and an image frame decryption method for transmitting safely multimedia in a real time.

2. Description of the Related Art

Multimedia is information media used for storing or transmitting complex information that consists of characters, voices, figures, images, etc. Multimedia requires a large space for digitalizing and storing, is difficult to treat, and needs a large bandwidth for transmitting. Also, since multimedia is an aggregate of information with different forms, it is easy to analogize one part from another part. Moreover, it is difficult to recognize intuitively volume and importance of information included in the media during generation.

Since multimedia has a large processing quantity and it is difficult to measure quantitatively importance and size thereof, multimedia is spread in a state where a safety system or a security system for preventing illegal access or damage are not prepared. This causes leakage of private information and security information, loss of worth, and invasion of privacy. Therefore, it is important to encrypt multimedia during storage or transmission for protecting from illegal access, illegal transformation, copy, distortion, and information leakage.

The large size of multimedia may be compressed based on structural features of images for saving storage space and transmitting efficiently. Therefore, the large sized multimedia has peculiar structural features according to the compression method.

Real-time multimedia like picture communication, monitoring camera, and live broadcasting is usually compressed using the Moving Picture Experts Group 4 (MPEG4) method. MPEG4 compression method comprises removing repeated color values of each of unit blocks of an image and replacing repetition between images in near time to a reference color value.

Methods for encrypting before compression and methods for encrypting after compression are now used as methods for encrypting multimedia. Since methods for encrypting after compression have large time complexity, they have low usefulness in a situation where the size of multimedia increases.

A naive algorithm and a selective algorithm are methods for encrypting before compression.

According to the naive algorithm, the whole of the uncompressed multimedia is encrypted like encrypting documents. Since the whole of the large sized multimedia is encrypted according to the naive algorithm, the naive algorithm causes a large consumption of time and resource for encrypting. Also, since structural features of multimedia are broken, the compression rate decreases.

On the other hand, according to the selective algorithm, since only a selective part of the multimedia is encrypted with reference to structural features of multimedia, encryption efficiency is improved. However, since the whole of the multimedia is not encrypted, a part of the multimedia may be exposed.

### SUMMARY OF THE INVENTION

The present invention has been made in an effort to provide an image frame encryption method for improving compression rate and saving time and resource even when encrypting before compressing the multimedia.

An image frame encryption apparatus according to an exemplary embodiment of the present invention generates a key frame, performs XOR with an image frame and the key frame to generate a temporary image frame and changes positions of blocks of the temporary image frame according to a first key to generate an encrypted image frame.

The image frame encryption apparatus may generate a seed frame and changes positions of blocks of the seed frame according to a second key to generate the key frame.

Also, the image frame encryption apparatus may randomly select one or more color values, and decides randomly positions of the one or more color values to generate the seed frame.

An image frame encryption apparatus according to another exemplary embodiment of the present invention generates a key frame, changes positions of blocks of an image frame according to a first key to generate a temporary image frame, and performs XOR with the key frame and the temporary image frame to generate an encrypted image frame.

An image frame decryption apparatus according to an exemplary embodiment of the present invention receives an encrypted image frame, generates a key frame, changes positions of blocks of the encrypted image frame according to a first key to generate a temporary image frame, and performs XOR with the temporary image frame and the key frame to generate the image frame.

The image frame decryption apparatus may receive a seed frame, and change positions of blocks of the seed frame according to a second key to generate the key frame.

Also, the image frame decryption apparatus may receive a compressed image frame, and decompress the compressed image frame to generate the encrypted image frame.

An image frame decryption apparatus according to another exemplary embodiment of the present invention receives an encrypted image frame, generates a key frame, performs XOR with the encrypted image frame and the key frame to generate a temporary image frame, and changes positions of blocks of the temporary image frame according to a first key to generate the image frame.

### BRIEF DESCRIPTION OF THE DRAWINGS

FIG. 1 is a block diagram representing roughly an image encryption apparatus according to a first exemplary embodiment of the present invention.

FIG. 2 is a flow chart representing roughly an image encryption method according to the first exemplary embodiment of the present invention.

FIG. 3 shows roughly a block exchange operation according to an exemplary embodiment of the present invention.

FIG. 4 shows a key frame according to an exemplary embodiment of the present invention.

FIG. 5 shows an encrypted frame according to an exemplary embodiment of the present invention.

FIG. 6 is a block diagram representing roughly an image frame decryption apparatus according to the first exemplary embodiment of the present invention.

FIG. 7 is a flow chart representing roughly an image frame decryption method according to the first exemplary embodiment of the present invention.

FIG. 8 is a block diagram representing roughly an image encryption apparatus according to a second exemplary embodiment of the present invention.

FIG. 9 is a flow chart representing roughly an image encryption method apparatus according to the second exemplary embodiment of the present invention.

FIG. 10 is a block diagram representing roughly an image frame decryption apparatus according to the second exemplary embodiment of the present invention.

FIG. 11 is a flow chart representing roughly an image frame decryption method according to the second exemplary embodiment of the present invention.

FIG. 12 shows compression rates according to various encryption methods.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Unless explicitly described to the contrary, the word “comprise” will be understood to imply the inclusion of stated elements but not the exclusion of any other elements. In addition, the word “unit” will be understood to be for processing a predetermined function or operation, which may be realized by hardware, software, or a combination thereof.

A moving picture is realized by rapidly switching a plurality of still images. In the following detailed description, a still unit image of the moving picture or a general still image will be called by a frame. The frame is logically divided into square pieces having a predetermined size. In the following detailed description, these square pieces will be called a macro block or a block. Therefore, the frame consists of a plurality of blocks.

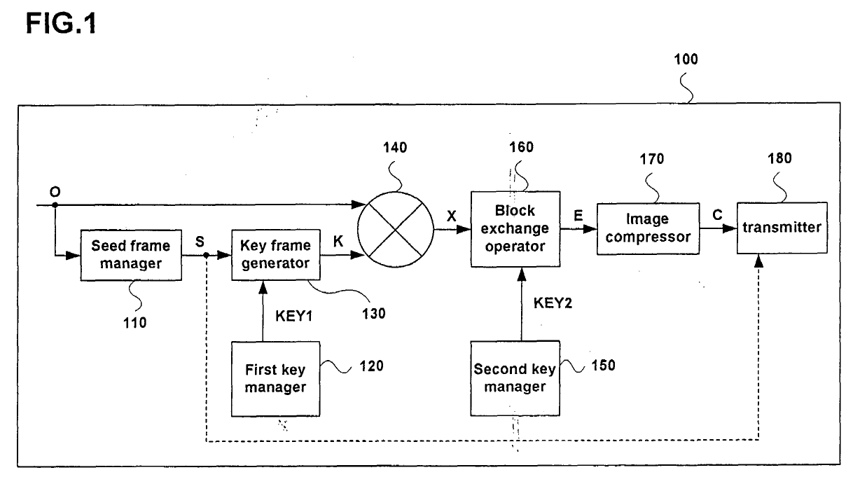

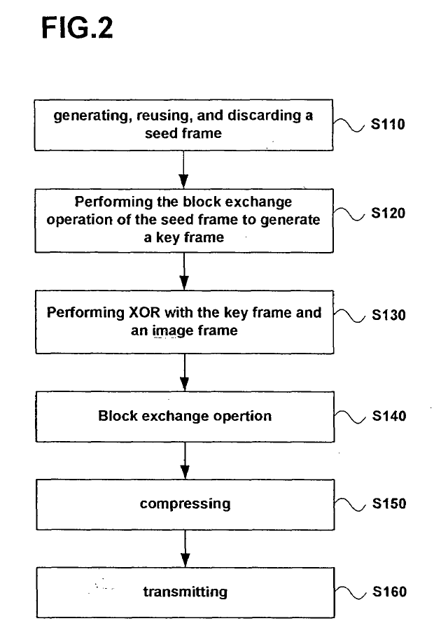

An image encryption method according to the first exemplary embodiment of the present invention will be now described with reference to FIG. 1 and FIG. 2.

FIG. 1 is a block diagram representing roughly an image encryption apparatus according to the first exemplary embodiment of the present invention.

As shown in FIG. 1, the image encryption apparatus 100 comprises a seed frame manager 110, a first key manager 120, a key frame generator 130, an XOR (exclusive OR) operator 140, a second key manager 150, a block exchange operator 160, an image compressor 170, and a transmitter 180.

The seed frame manager 110 generates, reuses and discards a seed frame S. The seed frame manager 110 may generate the seed frame S using randomly selected colors and positions of the colors.

The first key manager 120 generates, reuses, discards and manages a seed frame block exchange operation key KEY1 that the key frame generator 130 uses for the block exchange operation.

The key frame generator 130 performs the block exchange operation for the seed frame S using the seed frame block exchange operation key KEY1 to generate a key frame K.

The XOR operator 140 performs XOR with the image frame O and the key frame K to generate a temporary image frame X.

The second key manager 150 generates, reuses, discards, and manages an image frame encryption key KEY2 that the block exchange operator 160 uses for the block exchange operation.

The block exchange operator 160 performs the block exchange operation for the temporary image frame X using the image frame encryption key KEY2 to generate an encrypted image frame E.

The image compressor 170 compresses the encrypted image frame E to generate a compressed image frame C.

The transmitter 180 transmits the compressed image frame C to a channel. Also, the transmitter 180 may periodically transmit the seed frame S or a compressed seed frame S to the channel. Moreover, the transmitter 180 may transmit periodically information on the number of colors, each of the color values, and the position of the colors for generating new seed frame S to the channel.

FIG. 2 is a flow chart representing roughly an image encryption method according to the first exemplary embodiment of the present invention.

Firstly, the seed frame manager 110 decides to generate, reuse and discard the seed frame S in step S110. The seed frame manager 110 may select one or more color values and randomly decide positions of selected color values to generate a seed frame S that is a seed for encrypting images.

For example, the seed frame manager 110 randomly decides the number N_{sc} of color values for making the seed frame S. Next, the seed frame manager 110 randomly decides N_{sc} color values. The seed frame manager 110 may randomly decide N_{sc} color values by selecting one among values (for example, values between 0x00 and 0x05) near to 0x00 or values (for example, values between 0xFA and 0xFF) near to 0xFF for each of red, green and blue colors. The seed frame manager 110 may randomly decide positions of N_{sc} color values to generate the seed frame S.

The seed frame manager 110 may generate the seed frame S with color values such as RGB(253,253,0), RGB(253,0,253), RGB (0,253,253), etc. It enables the compression rate of a result frame of the XOR operator 140 to be lowered. If component color values of the seed frame S are decided to be values that are not near to 0x00 or 0xFF, pixels of each of the blocks of an output frame of the XOR operator 140 have a larger difference therebetween. Since pixels of each of the blocks lose similarity, the compression rate is greatly lowered according to the compression method to remove repeated color values of each of the frames.

The key frame generator 130 performs the block exchange operation for the seed frame S output from the seed frame manager 110 using the seed frame block exchange operation key KEY1 to generate the key frame K in step S120. The key frame generator 130 repeatedly or recursively performs the block exchange operation to generate the key frame K. The block exchange operation is an operation to mix up positions of blocks of an image frame O according to a predetermined rule. Here, the predetermined rule is obtained from a hash function and the seed frame block exchange operation key KEY1. That is, the key frame generator 130 mixes up positions of blocks of the seed frame S using the hash function and the seed frame block exchange operation key KEY1 to generate the key frame K. The key frame generator 130 may perform generation, change, and discard of the hash function, and setting up the rule for the hash function. The key frame generator 130 may perform the block exchange operation for the seed frame S according to Equation 1.

### [Equation 1]

TR[i]=KEY1[i]ηB[i]

In Equation 1, ‘i’ is the block number of a block of the seed frame S for the block exchange operation, ‘B[i]’ is a block of the seed frame S for the block exchange operation, and ‘KEY1[i]’ is an i-th element of the seed frame block exchange operation key KEY1. ‘TR[i]’ is a position that ‘B[i]’ is moved to, and η is the hash function to get the positions that blocks are moved to.

More precisely, according to Equation 2 the key frame generator 130 may get a position j of a block that is changed with the i-th block S(i) of the seed frame S.

### [Equation 2]

j=KEY1[i] mod Nₛ

In Equation 2, ‘mod’ operator is an operator to calculate the remainder of a division, and ‘Nx’ is the total number of blocks of the seed frame S.

The key frame generator 130 gets a position j of a block that is changed with the i-th block S(i), and changes the i-th block with the j-th block. The key frame generator 130 performs the block exchange operation for all i (0≦i<NF) according to Equation 3.

### [Equation 3]

```
BEGIN
    for i=0 to NF−1 do
    BEGIN
        j = KEY1[i] mod N_{S}
        SWAP( S[j], S[i] )
    END OF FOR
END
```

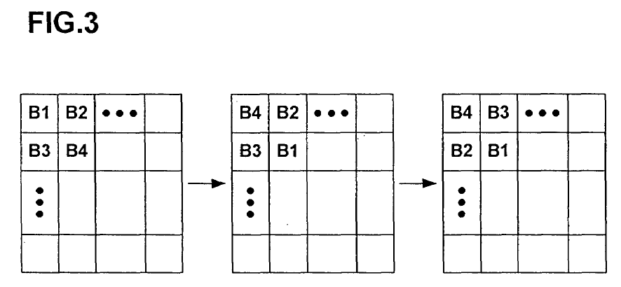

FIG. 3 shows roughly a block exchange operation according to an exemplary embodiment of the present invention.

As shown is FIG. 3, if the block exchange operation of the frame is performed, positions of blocks of the frame are changed.

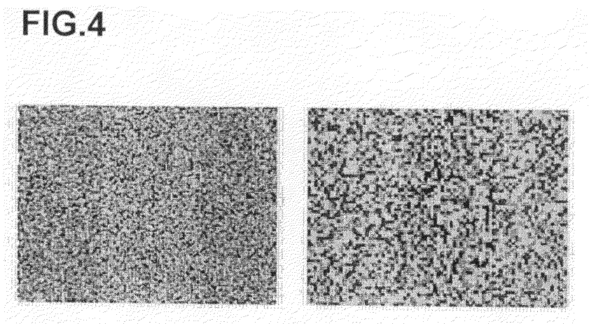

The key frame generator 130 performs the block exchange operation, such as in FIG. 3, to generate the key frame K, such as FIG. 4.

FIG. 4 shows a key frame according to an exemplary embodiment of the present invention.

Continually, FIG. 2 will be now described.

The XOR operator 140 performs XOR with the key frame K from the key frame generator 130 and the image frame O to generate a temporary image frame X in step S130. Equation 4 shows a operation that the XOR operator 140 performs.

### [Equation 4]

X=O⊕K

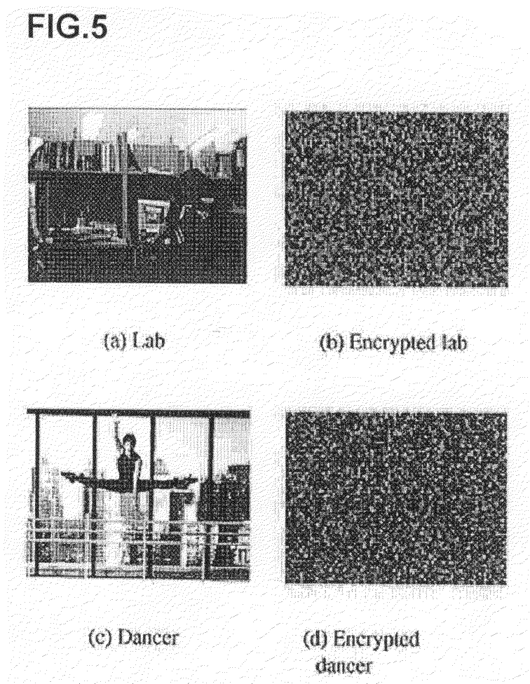

The block exchange operator 160 performs the block exchange operation for the temporary image frame X output from the XOR operator 140 using the image frame encryption key KEY2 to generate an encrypted image frame E in step S140. The block exchange operator 160 repeatedly or recursively performs the block exchange operation to generate the encrypted image frame E. The block exchange operator 160 may perform functions equal to or similar to functions of the key frame generator 130 like Equation 1. The block exchange operator 160 may perform generation, change, and discard of the hash function, and perform setting up the rule for the hash function. On the other hand, the seed frame block exchange operation key KEY1 may be equal to or different from the image frame encryption key KEY2. An example of the encrypted image frame E that the block exchange operator 160 generates is shown in FIG. 5.

FIG. 5 shows an encrypted frame according to an exemplary embodiment of the present invention.

As shown in FIG. 5, after the image frame O is encrypted, it is unrecognizable.

The image compressor 170 compresses the encrypted image frame E according to a predetermined rule to generate a compressed frame C in step S150. The image compressor 170 may compress the encrypted image frame E according to an MPEG4 method to remove repeated color values in each of the blocks of the encrypted image frame E. The image compressor 170 may compress the seed frame S to generate a compressed seed frame S.

The transmitter 180 transmits the compressed image frame C to a channel in step S160. Also, the transmitter may periodically transmit the seed frame S or the compressed seed frame to the channel. Moreover, the transmitter 180 may transmit periodically information on the number of colors, each of the color values, and the position of the colors for generating new seed frame S to the channel.

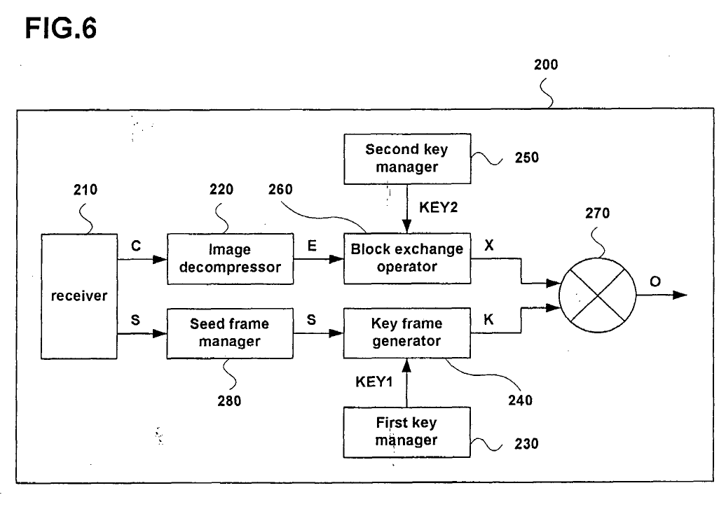

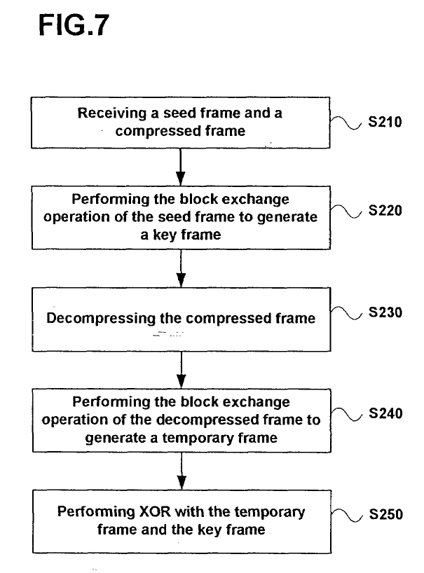

An image frame decryption method according to the first exemplary embodiment of the present invention will be now described with reference to FIG. 6 and FIG. 7.

FIG. 6 is a block diagram representing roughly an image frame decryption apparatus according to the first exemplary embodiment of the present invention.

As shown in FIG. 6, the image frame decryption apparatus 200 according to the first exemplary embodiment of the present invention comprises a receiver 210, an image decompressor 220, a seed frame manager 280, a first key manager 230, a key frame generator 240, a second key manager 250, a block exchange operator 260, and an XOR operator 270.

Since the first key manager 230 and the second key manager 250 perform functions equal to or similar to functions of the first key manager 120 and the second key manager 150, their detailed descriptions will be omitted.

FIG. 7 is a flow chart representing roughly an image frame decryption method according to the first exemplary embodiment of the present invention.

Firstly, the receiver 210 receives a compressed image frame C in step 210. Also, the receiver 210 may periodically receive a seed frame S or a compressed seed frame S. Moreover, the receiver 210 may periodically receive information on the number of colors, each of the color values, and the position of the color for generating seed frame.

The seed frame manager 280 uses, reuses, discards and manages a seed frame S that the receiver 210 receives. Also, the seed frame manager 280 may decompress the compressed seed frame S that the receiver 210 receives. Moreover, the seed frame manager 280 may generate the seed frame S with received information about the seed frame.

Next, the key frame generator 240 performs the block exchange operation for the seed frame S output from the seed frame manager 280 using the seed frame block exchange operation key KEY1 to generate a key frame K in step S220.

On the other hand, the image decompressor 220 decompresses the compressed image frame C to generate an encrypted image frame E in step S230.

After this, the block exchange operator 260 performs the block exchange operation for the encrypted image frame E output from the image decompressor 220 using the image frame encryption key KEY2 to generate a temporary image frame X in step S240.

The XOR operator 270 performs XOR with the temporary image frame X output from the block exchange operator 260 and the key frame K output from the key frame generator 240 to generate a finally-restored image frame O in step S250.

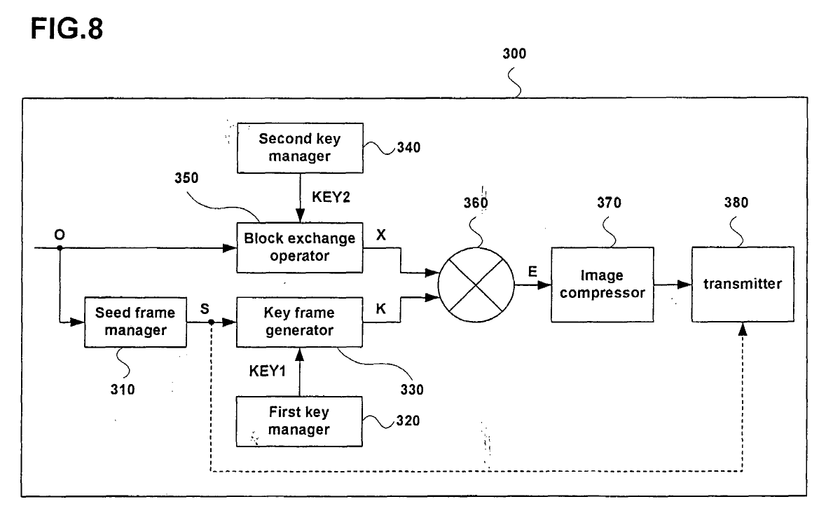

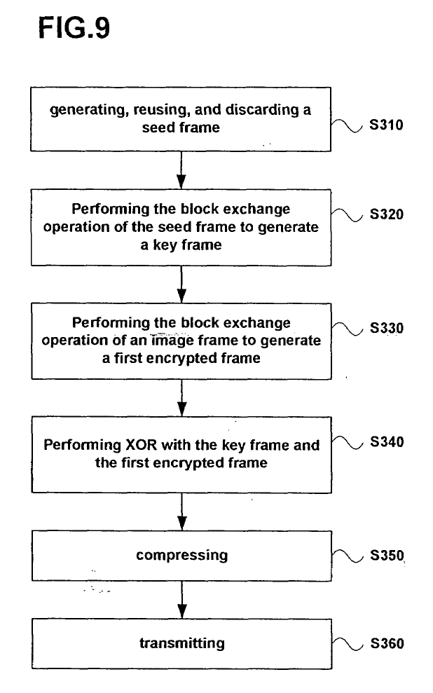

An image encryption method according to a second exemplary embodiment of the present invention will be now described with reference to FIG. 8 and FIG. 9.

FIG. 8 is a block diagram representing roughly an image encryption apparatus according to the second exemplary embodiment of the present invention.

As shown in FIG. 8, the image encryption apparatus 300 according to the second exemplary embodiment of the present invention comprises a seed frame manager 310, a first key manager 320, a key frame generator 330, a second key manager 340, a block exchange operator 350, an XOR operator 360, an image compressor 370, and a transmitter 380.

Since the first key manager 320 and the second key manager 340 perform functions equal to or similar to functions of the first key manager 120 and the second key manager 150, their detailed descriptions will be omitted.

FIG. 9 is a flow chart representing roughly an image encryption method apparatus according to the second exemplary embodiment of the present invention.

Firstly, the seed frame manager 310 generates, reuses, discards, and manages a seed frame S in step S310. The seed frame manager 310 may generate the seed frame S using randomly selected colors and positions of the colors.

Next, the key frame generator 330 performs the block exchange operation for the seed frame S output from the seed frame manager 310 using the seed frame block exchange operation key KEY1 to generate a key frame K in step S320.

On the other hand, the block exchange operator 350 performs a block exchange operation for the image frame O using the image frame encryption key KEY2 to generate a temporary image frame X in step S330.

The XOR operator 360 performs XOR with the temporary image frame X output from the block exchange operator 350 and the key frame K output from the key frame generator 330 to generate an encrypted image frame E in step S340.

The image compressor 370 compresses the encrypted image frame E to generate a compressed image frame C in step S350.

The transmitter 380 transmits the compressed image frame C to a channel. Also, the transmitter 380 may periodically transmit the seed frame S or the compressed seed frame S to the channel. Moreover, the transmitter 380 may transmit periodically information on the number of colors, each of the color values, and the position of the colors for generating new seed frame S to the channel.

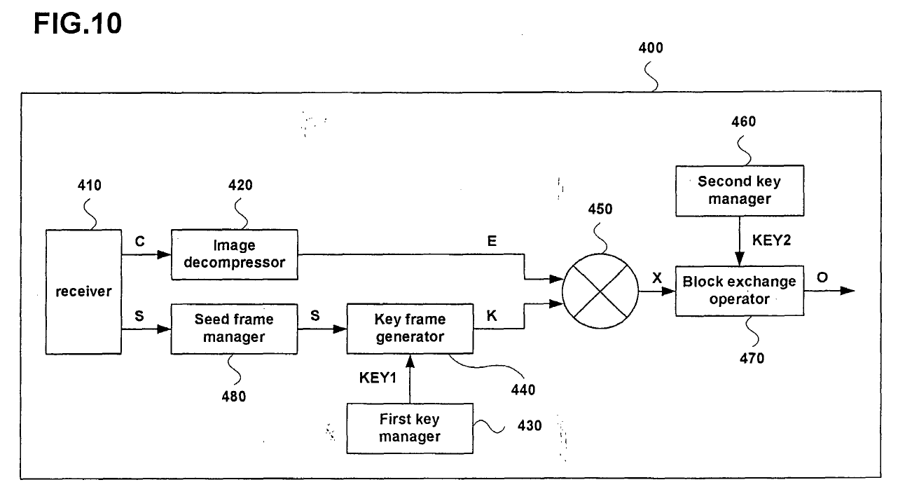

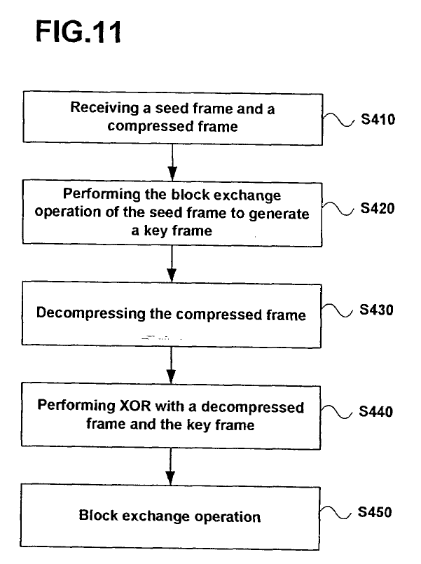

An image frame decryption method according to the second exemplary embodiment of the present invention will be now described with reference to FIG. 10 and FIG. 11.

FIG. 10 is a block diagram representing roughly an image frame decryption apparatus according to the second exemplary embodiment of the present invention.

As shown in FIG. 10, the image frame decryption apparatus 400 according to the second exemplary embodiment of the present invention comprises a receiver 410, an image decompressor 420, a seed frame manager 480, a first key manager 430, a key frame generator 440, an XOR operator 450, a second key manager 460, and a block exchange operator 470.

Since the first key manager 430 and the second key manager 460 perform functions equal to or similar to functions of the first key manager 120 and the second key manager 150, their detailed descriptions will be omitted.

FIG. 11 is a flow chart representing roughly an image frame decryption method according to a second exemplary embodiment of the present invention.

Firstly, the receiver 410 receives a compressed image frame C in step S410. Also, the receiver 410 may periodically receive a seed frame S or a compressed seed frame S. Moreover, the receiver 410 may periodically receive information on the number of colors, each of the color values, and the position of the color for generating seed frame.

The seed frame manager 480 uses, reuses, discards, and manages a seed frame S that the receiver 410 receives. Also, the seed frame manager 480 may decompress the compressed seed frame S that receiver 410 receives. Moreover, the seed frame manager 480 may generate the seed frame S with received information about the seed frame S.

Next, the key frame generator 440 performs a block exchange operation for the seed frame S output from the seed frame manager 410 using the seed frame block exchange operation key KEY1 to generate a key frame K in step S420.

On the other hand, the image decompressor 420 decompresses the compressed image frame C to generate an encrypted image frame E in step S430.

The XOR operator 450 performs XOR with the encrypted image frame E output from the image decompressor 420 and the key frame K output from the key frame generator 440 to generate a temporary image frame X in step S440.

The block exchange operator 470 performs the block exchange operation for the temporary image frame X output from the XOR operator 450 using the image frame encryption key KEY2 to generate a finally-restored image frame O in step S450.

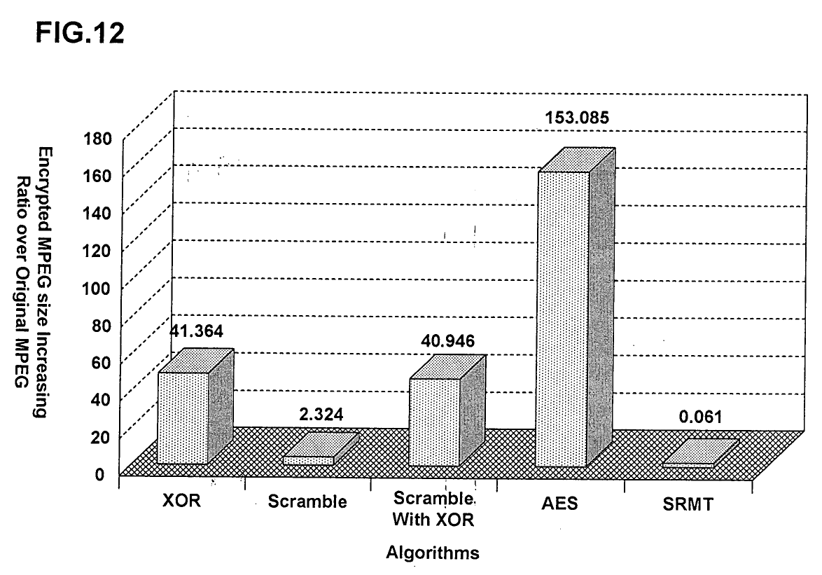

FIG. 12 shows encrypted MPEG size increasing ratios of various algorithms over an original MPEG size.

In FIG. 12, ‘AES’ represents the Advanced Encryption Standard, and ‘XOR’ represents encryption through XOR. Also, ‘Scramble with XOR’ represents encryption with XOR and scrambling, and ‘SRMT (Secure Real-time Media Transmission)’ represents encryption according to exemplary embodiments of the present invention.

In FIG. 12, the encrypted MPEG size increasing ratios of various algorithms over an original MPEG size are calculated according to Equation 5.

$$increasingratio = \frac{Encrypted MPEG size - Original MPEG size}{Original MPEG size} \qquad [ Equation 4 ]$$

As shown in FIG. 12, the encryption algorithm according to exemplary embodiments of the present invention has smaller increasing ratio than other encryption algorithms.

According to exemplary embodiments of the present invention, the image encryption apparatus can efficiently encrypt multimedia without reference to features of the multimedia like quantity of movement.

Also according to exemplary embodiments of the present invention, since the image encryption apparatus encrypts image frames with reference to structural features of image compression, time and resource for encryption can be reduced and compression rate is not greatly reduced. Therefore, the image encryption methods according to exemplary embodiments of the present invention are used in real-time transmission of multimedia.

Further, according to exemplary embodiments of the present invention, since the image encryption apparatus randomly decides N_{sc} color values by selecting one among values (for example, values between 0x00 and 0x05) near to 0x00 or values (for example, values between 0xFA and 0xFF) near to 0xFF for each of red, green and blue, the compression rate can be further improved.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for encrypting an image frame, comprising:
generating a key frame;
performing XOR with the image frame and the key frame to generate a temporary image frame; and
changing positions of blocks of the temporary image frame according to a first key to generate an encrypted image frame.

2. The method of claim 1, wherein generating the key frame comprises:
generating a seed frame; and
changing positions of blocks of the seed frame according to a second key to generate the key frame.

3. The method of claim 2, wherein generating the seed frame comprises:
selecting randomly one or more color values; and
deciding randomly positions of the one or more color values to generate the seed frame.

4. The method of claim 3, wherein changing positions of blocks of the seed frame comprises:
changing repeatedly positions of blocks of the seed frame according to the second key to generate the key frame.

5. The method of claim 3, wherein changing positions of blocks of the seed frame comprises:
changing recursively positions of blocks of the seed frame according to the second key to generate the key frame.

6. The method of claim 3, further comprising:
removing repeated color values in each of the blocks of the encrypted image frame to generate a compressed frame.

7. A method for encrypting an image frame, comprising:
generating a key frame;
changing positions of blocks of the image frame according to a first key to generate a temporary image frame; and
performing XOR with the key frame and the temporary image frame to generate an encrypted image frame.

8. The method of claim 7, wherein generating the key frame comprises:
generating a seed frame; and
changing positions of blocks of the seed frame according to a second key to generate the key frame.

9. The method of claim 8, wherein generating the seed frame comprises:
selecting randomly one or more color values; and
deciding randomly positions of the one or more color values to generate the seed frame.

10. A method for decrypting an image frame, comprising:
receiving an encrypted image frame;
generating a key frame;
changing positions of blocks of the encrypted image frame according to a first key to generate a temporary image frame; and
performing XOR with the temporary image frame and the key frame to generate the image frame.

11. The method of claim 10, wherein generating the key frame comprises:
receiving a seed frame; and
changing positions of blocks of the seed frame according to a second key to generate the key frame.

12. The method of claim 10, wherein generating the key frame comprises:
receiving information on the number of colors, each of the color values, and the position of the colors to generate a seed frame; and
changing positions of blocks of the seed frame according to a second key to generate the key frame.

13. The method of claim 12, wherein receiving the encrypted image frame comprises:
receiving a compressed image frame; and
decompressing the compressed image frame to generate the encrypted image frame.

14. A method for decrypting an image frame, comprising:
receiving an encrypted image frame;
generating a key frame;
performing XOR with the encrypted image frame and the key frame to generate a temporary image frame; and
changing positions of blocks of the temporary image frame according to a first key to generate the image frame.

15. The method of claim 14, wherein generating the key frame comprises:
receiving a seed frame; and
changing positions of blocks of the seed frame according to a second key to generate the key frame.

16. The method of claim 14, wherein generating the key frame comprises:
receiving information on the number of colors, each of the color values, and the position of the colors to generate a seed frame with the information; and
changing positions of blocks of the seed frame according to a second key to generate the key frame.

17. The method of claim 16, wherein
receiving a compressed image frame; and
decompressing the compressed image frame to generate the encrypted image frame.
